(19) United States
(12) Patent Application Publication
(10) Pub. No.: US 2007/0292027 A1
(43) Pub. Date: Dec. 20, 2007

(54) Method, medium, and system extracting text using stroke filters

(75) Inventors: Cheol Kon Jung, Suwon-si (KR); Qifeng Liu, Beijing (CN); Ji Yeun Kim, Seoul (KR); Young Su Moon, Seoul (KR); Sang Kyun Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/652,044

(22) Filed: Jan. 11, 2007

(30) Foreign Application Priority Data
Jun. 20, 2006 (KR) 10-2006-0055606

(51) Int. Cl. G06K 9/34

(52) U.S. Cl. 382/177

(57) ABSTRACT

A method, medium, and system extracting text, including filtering a text domain image using a stroke filter, determining a color polarity of the text by using a response value of the stroke filter, binarizing the response value of the stroke filter, and expanding a local domain by using a binary domain generated by the binarization.

### CROSS-REFERENCE TO RELATED APPLICATIONS

This application claims priority from Korean Patent Application No. 10-2006-0055606, filed on Jun. 20, 2006, in the Korean Intellectual Property Office, the disclosure of which is incorporated herein by reference.

### BACKGROUND OF THE INVENTION

1. Field of the Invention

One or more embodiments of the present invention relate to a text extraction method, medium, and system extracting text, and more particularly, to a method, medium, and system extracting captions included in an image by using stroke filters.

2. Description of the Related Art

Since text in captions of videos provides important content information, of a semantic level, the text represents very important image information usable for video summarization and search services. For example, text within captions, included in a video image, may be used for easily and quickly replaying and editing a key scene from a news segment of a certain theme or sports game, such as in baseball games. Similarly, customized broadcasting services may be implemented through captions detected within video of a personal video recorder (PVR), a WiBro device, and a digital multimedia broadcasting (DMB) phone, for example.

To capture the text from such captions, representative of important image information for the video, the text must first be extracted from the background of an image. Conventionally, such techniques for such capturing techniques include thresholding, techniques based on clustering, techniques using optical character readers (OCRs).

A representative example of the thresholding technique includes identifying a value representing a maximum variance value with respect to a distribution of brightness values of the background and the text domain as a threshold.

This thresholding technique i a difference in brightness between the text domain and the background domain is notable but it is difficult to extract text when the brightness of the background domain, in a domain including the text domain, is typically similar to the brightness of the text domain.

The clustering technique includes generating a candidate domain by reducing the number of color values, and a text domain is captured by domain-filtering based on a constraint condition, such as size.

In this case, the text domain is identified by assuming that the text domain has a similar color value. Accordingly, similar to the thresholding technique, the clustering technique is ideal when the difference in brightness between a text domain and a background domain is notable, but is less reliable in extracting text when there is a domain that has similar colors to the text domain in a background.

Also, since these two techniques, thresholding and clustering, commonly do not consider the color polarity of a text domain, a process of determining the color polarity is also needed.

The additional optical character reader (OCR) technique proposing extracting a text domain by establishing several thresholds, recognizing the text domain with respect to each domain by using the OCR, and identifying the highest recognition result value as being a text domain extraction result.

Here, with the OCR technique, the acquiring of the color polarity of the text domain is performed together. However, since text recognition is performed with respect to various cases, processing times are increased.

Embodiments, at least as discussed below, overcome such drawbacks.

### SUMMARY OF THE INVENTION

One or more embodiments include a method, medium, and system extracting text, capable of more precisely and quickly extracting a text domain of a caption detected from a video, by using stroke filters.

One or more embodiments include a method, medium, and system extracting text, in which a color polarity of the text is determined by using a response value of a stroke forming the text, thereby improving precision of color polarity determination.

One or more embodiments include a method, medium, and system extracting text, in which a non-stroke background domain is removed by stroke filters, thereby improving performance of the extracting of the text domain.

One or more embodiments include a method, medium, and system extracting text, in which response values of stroke filters, used in detecting the text, are used, thereby reducing calculation requirements and reducing processing times used in text extraction.

Additional aspects and/or advantages of the invention will be set forth in part in the description which follows and, in part, will be apparent from the description, or may be learned by practice of the invention.

To achieve the above and/or other aspects and advantages, embodiments of the present invention include a method of extracting text from video data, including filtering a text domain image within the video data using a stroke filter, determining a color polarity of text of the text domain using a response value of the stroke filter, binarizing the response value of the stroke filter based on the determined color polarity, and expanding a local domain for the text domain by using a binary domain generated by the binarization of the binarizing of the response value of the stroke filter.

To achieve the above and/or other aspects and advantages, embodiments of the present invention include at least one medium including computer readable code to control at least one processing element to implement an embodiment of the present invention.

To achieve the above and/or other aspects and advantages, embodiments of the present invention include a text extraction system, including a stroke filter unit to filter a text domain within video data using a stroke filter, a text color polarity determiner to determine a color polarity of text of the text domain by using a response value of the stroke filter unit, a binarization performer to perform binarization with respect to the response value of the stroke filter unit and based on the determined color polarity, and a local domain expander to expand a local domain for the text domain by using a binary domain made by the binarization the response value of the stroke filter by the binarization performer and to output a corresponding result to an OCR.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a stroke filter, according to an embodiment of the present invention;

FIG. 2 illustrates a text extraction method, according to an embodiment of the present invention;

FIG. 3 illustrates an example for describing operation S220 shown in FIG. 2, in portions (a)-(c), according to an embodiment of the present invention;

FIG. 4 illustrates sub-operations of operation S240 shown in FIG. 2, according to an embodiment of the present invention;

FIG. 5 illustrating an example for the sub-operations of FIG. 4, through illustrated portions (a)-(d), according to an embodiment of the present invention;

FIG. 6 illustrates an example of an original image, results of extracting text according to a conventional technique, and results of extracting text according to an embodiment of present invention, in illustrated portions (a)-(c), respectively, when a background of the text is similar to a text color polarity;

FIG. 7 illustrates an example of an original image, results of extracting text according to a conventional technique, and results of extracting text according to another embodiment of present invention, in illustrated portions (a)-(c), respectively, when a background of the text is similar to a text color polarity;

FIG. 8 illustrates an example of a result of text extraction, according to an embodiment of the present invention;

FIG. 9 illustrates a text extraction system, according to an embodiment of the present invention; and

FIG. 10 illustrates a local domain expander, such as that shown in FIG. 9, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

Thus, according to an embodiment of the present invention, processes detecting captions from videos include localization processes of localizing text domains, binarization processes removing a background from the localized text domain, and recognition processes recognizing the text after the background has been removed.

Such binarization processes may include removing a background from a localized text domain, where the background has been precisely removed from a text domain using a stroke filter response value of a stroke filter, to increase text recognition rates and improve processing speeds. As understood, further discussion of such localization recognition processes will be further omitted.

A stroke filter according to an embodiment of the present invention, for example, can been seen in more detail in Korean Patent Application No. 10-2005-111432, filed on 2005. Accordingly, further discussion of such stroke filters will only be briefly further described below.

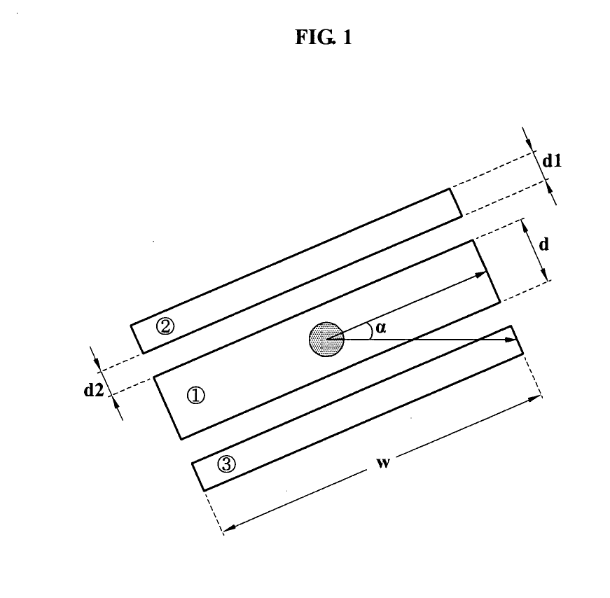

FIG. 1 illustrates an implementation of a stroke filter, according to an embodiment of the present invention. Referring to FIG. 1, the stroke filter may include a first filter \textcircled{1}, a second filter \textcircled{2}, and a third filter \textcircled{3} and detects a stroke of a text by using the first filter \textcircled{1}, the second filter \textcircled{2}, and the third filter \textcircled{3}.

When a length of the first filter \textcircled{1} is d, lengths d1 of the second filter \textcircled{2} and the third filter \textcircled{3} may correspond to ½ of the length of the first filter \textcircled{1}, for example. Also, a distance d2 between the first filter \textcircled{1} and the second filter \textcircled{2} may correspond to ½ of the length of the first filter \textcircled{1}, for example, and a distance between the first filter \textcircled{1} and the third filter \textcircled{3} may correspond to ½ of the length of the first filter \textcircled{1}. Here, it should be noted that such references should only be considered example, as embodiments of the present invention can be implemented with various filters, for example.

The stroke filter detects text strokes by changing an angle α of the stroke filter. For example, whenever rotating the angle α of the stroke filter by 0, 45, 90, and 135 degrees, strokes can be detected from pixel values of pixels included in the stroke filter.

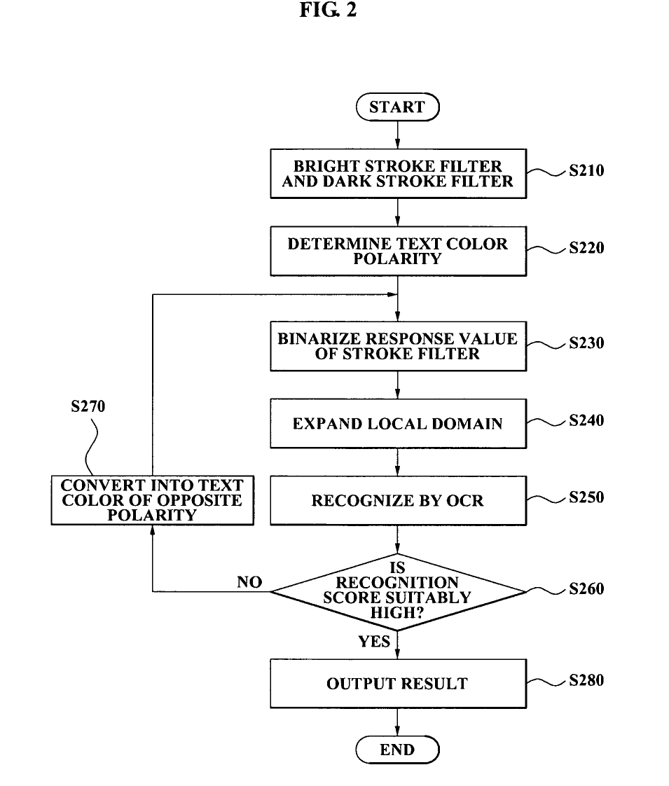

FIG. 2 illustrates a text extraction method using such a stroke filter, according to an embodiment of the present invention. Referring to FIG. 2, an image of a text domain is filtered by using a bright stroke filter and a dark stroke filter, in operation S210. A text color polarity of the image may further be determined, in operation S220, and a response value of the stroke filter binarized, in operation S230. A local domain may then be expanded, in operation S240, and recognition may be performed via an optical character reader (OCR) and then output, in operations S250 and S260, respectively. When a recognition score is lower than a predetermined value, e.g., as a result of the recognition of the OCR, the determined text color polarity of the image is converted into a text color of an opposite polarity and the binarizing is performed again.

In this case, the image of the text domain on which bright stroke filtering and dark stroke filtering are performed is a text domain of an image extracted by the localization process.

Hereinafter, example operations of this text extraction method, according to an embodiment of the present invention, will be described in greater detail.

In operation S210, the bright stroke filtering and the dark stroke filtering are performed on the image of the text domain extracted by the localization process, and a response value is acquired by each filtering.

In this case, the response values acquired by the bright stroke filtering and the dark stroke filtering may be expressed as shown in the below Equation 1 and Equation 2, for example.

R_{B}(α,d)=m₁−m₂+m₁−m₃−|m₂−m₃| Equation 1

R_{D}(α,d)=m₂−m₁+m₃−m₁−|m₂−m₃| Equation 2

Here, RB and RD indicate the response values of the bright stroke filter and the dark stroke filter, α indicates an angle of a gradient of the stroke filter, d indicates a length of the first filter \textcircled{1}, m1, m2, and m3 indicate means with respect to pixel values of pixels included in the first filter \textcircled{1}, second filter \textcircled{2}, and third filter \textcircled{3}, e.g., as shown in FIG. 1, respectively.

In operation S220, the text color polarity of the text having a bright or dark color polarity is determined through two techniques, according to polarities of the text and a background of the text.

As one of the two techniques, the color polarity of the text is determined by using a rate FR of a response value RB of the bright stroke filter and a response value RD of the dark stroke filter may be applied when the polarity of the background is different from the polarity of the text. See Equation 3, below.

F_{R}=ΣR_{B}/ΣR_{D} Equation 3

As shown in the above Equation 3, for example, the polarity of the text may be determined to be bright, when RB is much greater than RD, “FR>>1”, or the polarity of the text may be determined to be dark, when RB is much smaller than RD, “FR<<1”. Accordingly, when the polarity of the text is different from the polarity of the background, the color polarity of the text may be determined by using only a value of FR.

The other of the two techniques may be applied when the polarity of the text is similar to the polarity of the background, for example. When the polarity of the text is similar to the polarity of the background, since the value of FR is designated close to “1” with respect to both cases that the polarity of the text is bright or dark, the rate of a number of crossings in a binarized image as well as the value of FR may be used.

In this case, a rate FE of a number NB of bright crossings and a number of ND of dark crossings in the binarized image may be expressed as shown in the below Equation 4, for example.

F_{E}=ΣN_{B}/ΣN_{D} Equation 4

As known from Equation 4, the polarities of the text and the background may be considered bright when NB is less than ND, “FE<1”, for example, and the polarities of the text and the background may be considered dark when NB is much greater than ND, “FE>1”. Accordingly, when the polarities of the text are similar to the polarity of the background, the color polarity of the text may be determined by using both the value of FR, and the value of FE. Namely, when the value of the FR is close to “1” and the value of FE is less than “1”, the color polarity of the text may be determine to be bright, and when the value of FE is greater than “1”, the color polarity of the text may be determined to be dark.

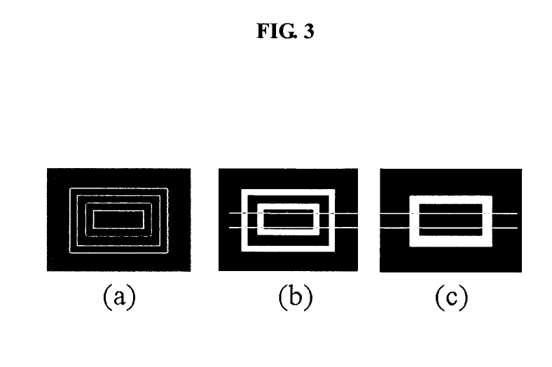

In FIG. 3, portion (a) illustrates an original image of a text domain, portion (b) illustrates a response image filtered by the dark stroke filter, and portion (c) illustrates a response image filtered by the bright stroke filter. Referring to portion (a), the text and background of an image of the text domain extracted the localization process demonstrate a bright polarity. Referring to portions (b) and (c), the numbers of crossings in a part of ⅓ and another part of ⅔ of the text domain in a binarized image may be recognized. Namely, as shown in portions (b) can (c) of FIG. 3, since ND number of crossings in the image filtered by the dark stroke filter is greater than NB number of crossings in the image filtered by the bright stroke filter, FE is less than 1 and the polarity of the text of the original image may be determined to be bright.

Measured values according to the color polarities of the background and the text in the two techniques of determining the color polarity are shown in the below Table 1, for example.

TABLE 1

| | BonD | DonB | BonB | DonD |
|---|---|---|---|---|
| F_{R} | >>1 | <<1 | ≈1 | ≈1 |
| F_{E} | ≈1 | ≈1 | <1 | >1 |

Here, BonD is an image including a bright text existing in a dark background, DonB is an image including a dark text existing in a bright background, BonB is an image including a bright text existing in a bright background, and DonD is an image including a dark text existing in a dark background.

These are four examples of determining the color polarity of the text, as shown in Table 1, and may be further expressed as below, according to one embodiment of the present invention.

When FR is greater than 1.1 (FR>1.1), the color polarity of the text may be determined to be bright, when FR is less than 0.9 (FR<0.9), the polarity of the text may be determined to be dark, when FR is greater than or equal to 0.9 and less than or equal to 1.1 (0.9≦FR≦1.1) and FE is less than or equal to 1 (FE≦1), the color polarity of the text may be determined to be bright, and when FR is greater than or equal to 0.9 and less than or equal to 1.1 (0.9≦FR≦1.1) and FE is greater than 1 (FE>1), the color polarity of the text may be determined to be dark.

Though such values have been referenced in this embodiment, such values used for determining the color polarity of the text, such as 0.9 and 1.1, are not fixed and may be changed depending upon circumstances. Thus, alternate embodiments are equally available.

When the color polarity of the text is determined in operation S220, a binarization process with respect to the response value of the stroke filter may be performed by using a threshold, in operation S230. A binarized domain acquired by operation S230 may be used for an initial seed domain to expand a local domain, for example. In this case, depending on embodiment, the threshold may be selectively assigned by a designer.

In operation S240, the local domain may further be expanded by using the binarized domain.

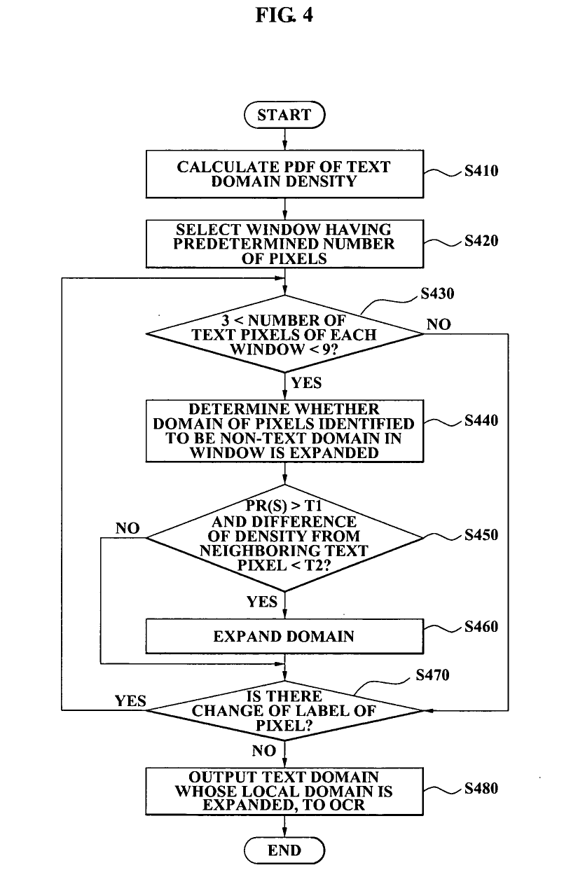

FIG. 4 illustrates sub-operations of operation S240 shown in FIG. 2, according to an embodiment of the present invention. Referring to FIG. 4, the process of expanding the local domain includes operation S410 includes calculating a probability density function (PDF) of text domain density by using a binarized stroke image and an original image, operations S420 through S440 include selecting a window whose number of pixels determined to be a text is 4 to 8 and determining whether to expand a domain of pixels in a non-text domain in the window, operation S460 includes expanding a corresponding pixel in the window, as the text domain when consistent with a domain expansion condition, operation S470 includes repeatedly performing operations S430 through S470 till there is no change in a label of the pixel, and operation S480 includes outputting the text domain whose local domain is expanded, to an OCR.

Here, when the domain expansion condition of the pixels is determined to be the non-text domain in the window the probability Pr(s) of each pixel is greater than a predetermined value T1 and a difference in density, with a neighboring text pixel, is less than a predetermined value T2. In this case, T1 and T2 may be 0.75 and 15, respectively, for only examples. Again, embodiments of the present invention are not limited to such values and T1 and T2 may be changed depending upon circumstances. The probability Pr(s) of the corresponding pixel may be determined by using a probability density function PDF(s), calculated as shown below in Equation 5, for example.

Pr(s)=PDF(s) Equation 5

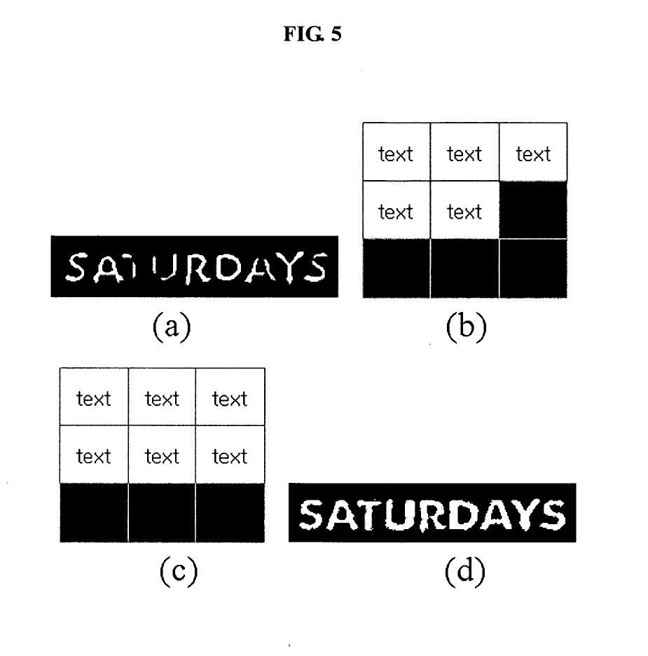

The process of expanding the local domain, illustrated in FIG. 4, will be described in greater detail with reference to FIG. 5.

In operation S410, a binarized stroke image and an original image of a text domain, shown in portion (a) of FIG. 5, may be received and the PDF of the text domain density calculated.

In operation S420, a window having a predetermined number of pixels, such as 9 of pixels, may be selected. Thereafter, in operation S430, it may be determined whether the number of pixels determined to be text is represented by 4 to 8 pixels in a corresponding window.

When the number of pixels determined to be the text in the window is 4 to 8 pixels, as a result of the determination of operation S430, operations S440 through operation S470 may be performed. When the number of pixels determined to be the text in the window does not correspond to 4 to 8 pixels, operation S470 may be performed.

When the number of pixels determined to be the text in the window is 4 to 8 pixels, for example, as shown in portion (b) of FIG. 5, where the number of pixels is 5, in operation S440, it may be determined whether to expand the pixels determined to be the non-text domain into the text domain. For example, when it is determined whether to expand a sixth pixel of the window shown in portion (b) of FIG. 5 into the text domain, the sixth pixel may be expanded into the text domain as shown in portion (c) of FIG. 5 when the probability Pr(s) with respect to a corresponding pixel is greater than the value of T1 and the difference in density from a neighboring pixel, e.g., a fifth pixel, is less than the value of T2.

When the process of domain expansion is performed with respect to the entire window of the text domain and a change in a label of the pixel does further not occur in operation S470, a text domain portion (d) of FIG. 5 may be output to the OCR, in operation S480.

When operation S420 of expanding the local domain is performed via a series of processes, in the aforementioned operation S250, the OCR may recognize the text domain in which the local domain is expanded.

Again, with reference to FIG. 2, in operation S260, when a score of recognizing the text domain by the OCR is suitably high, a corresponding result is output, and when the recognition score is low, operation S270 may be performed. In this case, whether the recognition score is high or low may be determined based on a predetermined value.

When the recognition score is low, in operation S270, the text color may be converted into the opposite polarity and operation S230 performed. Namely, the text color may be converted into the polarity opposite to the color polarity determined in operation S220, and operations S230 through S260 may be repeated.

As a result of experiments performing such processes according to one embodiment of the present invention, a precision in the determining of the color polarity was 97.4%, and a result of extracting the text was excellent.

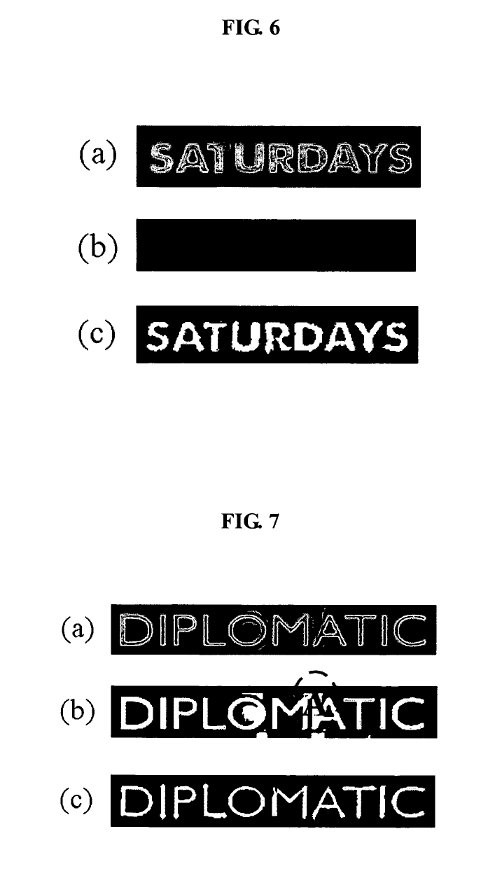

FIGS. 6 and 7 illustrate examples of such results of text extraction, according to an embodiment of the present invention. In FIG. 6, an image whose color polarity was difficult to determine is shown, and in FIG. 7, an image including a background whose color polarity is similar to the color polarity of the text domain is shown. In this case, in each of FIGS. 6 and 7, an original image is shown in portion (a), a result of an extracting of the text according to a conventional technique, e.g., using a threshold or clustering, is shown in portion (b), and a result of a text extraction according to an embodiment of the present invention is shown in portion (c), respectively.

As shown in FIG. 6, when the original image in portion (a) presents difficulties in determining the color polarity, e.g., because the color polarity of the background of the text being similar to the color polarity of the text, the text is not properly extracted by the conventional technique, as shown in portion (b) of FIG. 6, but is properly extracted in the text extraction result of an embodiment of present invention, in portion (c) of FIG. 6, as “SATURDAYS”.

Similarly, as shown in FIG. 7, when the color polarity of the background of the text is similar to the color polarity of the text, as shown in portion (a), the text is extracted together with parts of the background. For example, as shown in portion (b), an “A” is incorrectly extracted in the text extraction by the conventional technique. Alternatively, as shown in portion (c) of FIG. 7, a desired text domain is extracted without the background according to a text extraction result according to an embodiment of the present invention.

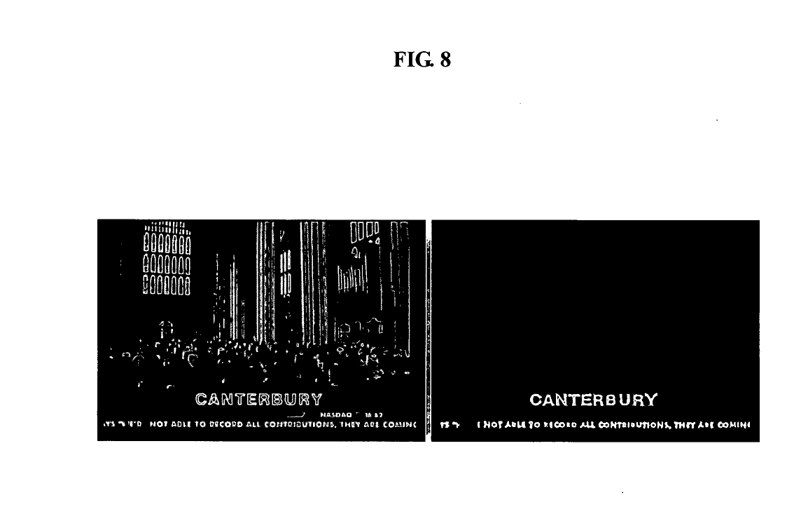

FIG. 8 further illustrates an example of a text extraction result according to a embodiment of the present invention, where text included in an image is precisely extracted.

Namely, a text color polarity of a text domain detected by a localization process is determined by the text extraction process of using a response value acquired by a stroke filter, according to an embodiment of the present invention, and an original image is converted into a binary image and locally expanded, thereby extracting the precise text domain from the original image.

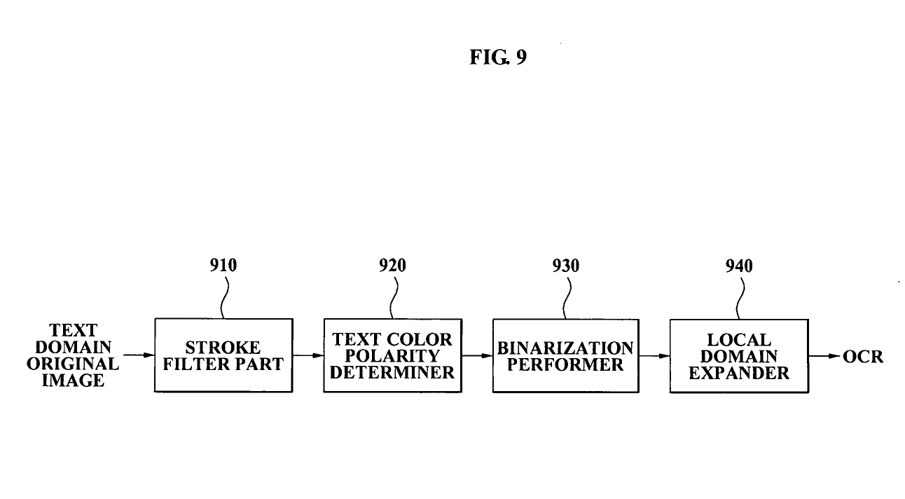

FIG. 9 further illustrates a text extraction system, according to an embodiment of the present invention. Referring to FIG. 9, the text extraction system includes a stroke filter unit 910, a text color polarity determiner 920, a binarization performer 930, and a local domain expander 940, for example.

The stroke filter unit 910 filters an original image of an input text domain by using stroke filters. In this case, the stroke filter unit 910 may perform all bright stroke filtering and dark stroke filtering and output response values, for example.

The text color polarity determiner 920 may determine a color polarity of the text by using the response value of the stroke filter unit 910. Here, the text color polarity may be determined by using a rate of the response values of the bright stroke filter and the dark stroke filter, for example. When the rate is greater than 1, the text color polarity may be determined to be bright, and when the rate is less than or equal to 1, the text color polarity may be determined to be dark.

In this case, a rate of a number of bright crossings to a number of dark crossings in a binarized image may be used. When the rate of the response values is from 0.9 and 1.1, the text color polarity may be determined to be bright when the rate of the numbers is less than or equal to 1 and may be determined to be dark when the rate of the number is greater than 1.

The binarization performer 930 may perform binarization of thetext domain with respect to the response values of the stroke filter unit 910. In this case, the binarization may be performed based on a simple threshold.

The local domain expander 940 may further expand a local domain by using a binarized domain, e.g., acquired by the binarization of the binarization performer 930, and output a result of the local domain expansion to an OCR to recognize the extracted text domain.

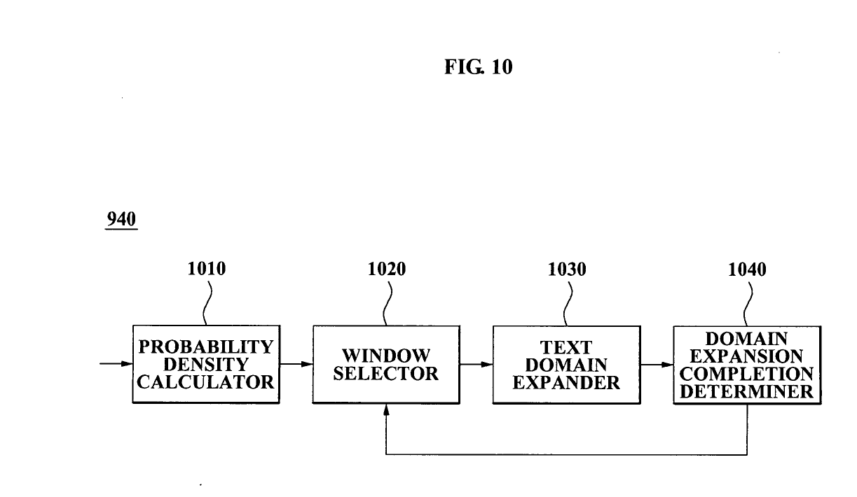

FIG. 10 illustrates the local domain expander 940, such as shown in FIG. 9, in greater detail. Referring to FIG. 10, the local domain expander 940 may include a probability density calculator 1010, a window selector 1020, a text domain expander 1030, and a domain expansion completion determiner 1040, for example.

The probability density calculator 1010 may calculate a PDF of text domain density by using a binarized stroke image and an original image.

The window selector 1020 may further selects a window having a predetermined number of pixels, such as 9 pixels, for example.

The text domain expander 1030 performs domain expansion when a probability P(s) of each pixel determined to be a non-text domain in the window selected by the window selector 1020 is less than a predetermined value T1, such as 0.75, and a difference in density from a neighboring pixel is less than a predetermined value T2, such as 15, again noting that alternative values are equally available.

The domain expansion completion determiner 1040 may still further determine a pixel label change of the binarized stroke image, send the binarized stroke image to the window selector 1040, and output a text domain in which a local domain is expanded, to the OCR, when there are no pixel label changes.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. Here, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

An aspect of an embodiment of the present invention provides a text extraction method, medium, and system in which a color polarity of a text is determined by using a response value of a stroke as a feature forming text, thereby improving precision of color polarity determination.

An aspect of an embodiment of the present invention further provides a text extraction method, medium, and system in which a non-stroke background domain is removed by stroke filters, thereby improving performance of an extracting of a text domain.

An aspect of an embodiment of the present invention further provides a text extraction method, medium, and system in which response values of stroke filters, used in a detecting of text, are used, thereby reducing calculation amounts to reduce processing times in text extraction.

An aspect of an embodiment of the present invention further provides a text extraction method, medium, and system in which text extraction is performed by a stroke, thereby providing a improved results when the color polarity of a background of text is similar to the color polarity of the text.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of extracting text from video data, comprising:
filtering a text domain image within the video data using a stroke filter;
determining a color polarity of text of the text domain using a response value of the stroke filter;
binarizing the response value of the stroke filter based on the determined color polarity; and
expanding a local domain for the text domain by using a binary domain generated by the binarization of the binarizing of the response value of the stroke filter.

2. The method of claim 1, further comprising:
inputting a result of the binarization of the expanded local domain into an optical character reader (OCR); and
repeating the binarizing of the response value of the stroke filter when a corresponding value recognized by the OCR is lower than a predetermined value.

3. The method of claim 2, wherein, in the repeating of the binarizing of the response value of the stroke filter, when the value recognized by the OCR is less than the predetermined value, the repeating of the binarizing of the response value of the stroke filter is based on a conversion of the color polarity into an opposite polarity.

4. The method of claim 1, wherein the stoke filtering comprises bright stroke filtering and dark stroke filtering.

5. The method of claim 1, wherein the color polarity of the text is determined based on a ratio of response values of a bright stroke filter and a dark stroke filter.

6. The method of claim 5, wherein the response values of the bright stroke filter and the dark stroke filter are respectively expressed as:
R_{B}(α,d)=m₁−m₂+m₁−m₃−|m₂−m₃|

R_{D}(α,d)=m₂−m₁+m₃−m₁−|m₂−m₃|

wherein R_{B} and R_{D} indicate response values of the bright stroke filter and the dark stroke filter, α indicates an angle of a gradient of the stroke filter, d indicates a length of a first filter, m₁, m₂, and m₃ indicate averages with respect to pixel values of pixels included in the first filter, a second filter, and a third filter, respectively.

7. The method of claim 5, wherein the color polarity of the text is determined to be bright when the ratio of the response values of the bright stroke filter and the dark stroke filter is greater than 1 and is determined to be dark when the ratio of the response values of the bright stroke filter and the dark stroke filter is less than 1.

8. The method of claim 1, wherein the color polarity is determined by a ratio of response values of a bright stroke filter and a dark stroke filter and a ratio of numbers of bright crossings and dark crossings in a binarized image.

9. The method of claim 8, wherein, when the ratio of the response values of the bright stroke filter and the dark stroke filter are within predetermined values, the color polarity of the text is determined to be bright when the ratio of the numbers of bright crossings and dark crossings is less than or equal to 1 and is determined to be dark when the ratio of the numbers of bright crossings and dark crossings is greater than 1.

10. The method of claim 9, wherein the predetermined values are 0.9 and 1.1.

11. The method of claim 1, wherein the expanding a local domain comprises:
calculating a probability density of a text domain density;
selecting a window having a predetermined number of pixels determined to represent text;
performing domain expansion when a rate of each pixel determined to be a non-text domain in the window is less than a predetermined value T1 and a difference of density from a neighboring pixel is less than a predetermined value T2; and
repeating the selecting the window until there is no change of labels of pixels.

12. The method of claim 11, wherein the probability density is calculated using text domains of a binary stroke image and an original image.

13. The method of claim 11, wherein the predetermined number of pixels determined is a range of 4 to 8 pixels.

14. The method of claim 11, wherein the predetermined values T1 and T2 are 0.75 and 15, respectively.

15. At least one medium comprising computer readable code to control at least one processing element to implement the method of claim 1.

16. A text extraction system, comprising:
a stroke filter unit to filter a text domain within video data using a stroke filter;
a text color polarity determiner to determine a color polarity of text of the text domain by using a response value of the stroke filter unit;
a binarization performer to perform binarization with respect to the response value of the stroke filter unit and based on the determined color polarity; and
a local domain expander to expand a local domain for the text domain by using a binary domain made by the binarization the response value of the stroke filter by the binarization performer and to output a corresponding result to an OCR.

17. The system of claim 16, wherein the stroke filer unit performs both bright stroke filtering and dark stroke filtering.

18. The system of claim 16, wherein the text color polarity determiner determines the color polarity of the text by using a rate of response values of a bright stroke filter and a dark stroke filter.

19. The system of claim 18, wherein the text color polarity determiner determines the color polarity of the text to be bright when the ratio of the response values of the bright stroke filter and the dark stroke filter is greater than 1, and to be dark when the ratio of the response values of the bright stroke filter and the dark stroke filter is less than 1.

20. The system of claim 16, wherein the text color polarity determiner determines the color polarity by a ratio of response values of a bright stroke filter and a dark stroke filter and a ratio of numbers of bright crossings and dark crossings in a binarized image.

21. The system of claim 20, when the ratio of the response values of the bright stroke filter and the dark stroke filter is within predetermined values, the text color polarity determiner determines the color polarity of the text to be bright when the ratio of the numbers bright crossings and dark crossings is less than or equal to 1 and to be dark when the ratio of the numbers bright crossings and dark crossings is greater than 1.

22. The system of claim 16, wherein the local domain expander comprises:
a probability density calculator to calculate a probability density of a text domain density;
a window selector to select a window having a predetermined number of pixels determined to represent text;
a text domain expander to perform domain expansion when a rate of each pixel determined to be a non-text domain in the window is less than a predetermined value T1 and a difference of density from a neighboring pixel is less than a predetermined value T2; and
a domain expansion completion determiner to initiate repetition of the selecting the window until there is no change of labels of pixels.

23. The system of claim 22, wherein the probability density calculator calculates the probability density of the text domain density by using text domains of a binary stroke image and an original image.

24. The system of claim 22, wherein the predetermined values T1 and T2 are 0.75 and 15, respectively.
